(19) United States
(12) Patent Application Publication
(10) Pub. No.: US 2026/0295573 A1
(43) Pub. Date: Oct. 1, 2026

(54) REGENERATION OF ANION EXCHANGE RESINS

(71) Applicants: UT-Battelle, LLC, Oak Ridge, TN (US); Georgia Tech Research Corporation, Atlanta, GA (US)

(72) Inventors: Radu Custelcean, Knoxville, TN (US); Constantinos Tsouris, Oak Ridge, TN (US); Jeffrey Einkauf, Knoxville, TN (US); Sotira Yiacoumi, Atlanta, GA (US); Zhuoyi Zeng, Brookhaven, GA (US)

(21) Appl. No.: 19/630,654

(22) Filed: Mar. 27, 2026

Related U.S. Application Data
(60) Provisional application No. 63/779,732, filed on Mar. 28, 2025.

(51) Int. Cl. B01J 49/57; B01J 41/05; B01J 41/14; B01J 47/02; B01J 49/07; B01J 49/60

(52) U.S. Cl. CPC B01J 49/57; B01J 41/05; B01J 41/14; B01J 47/02; B01J 49/07; B01J 49/60

(57) ABSTRACT

A method for regenerating a strong-base anion (SBA) exchange resin containing quaternary ammonium groups, the method comprising: (i) a first washing step in which the SBA exchange resin is washed with a first aqueous solution of a salt containing a divalent or trivalent anion, wherein the salt is present in the first aqueous solution in a concentration of at least 0.001 M and up to the solubility limit of the salt; and (ii) a second washing step in which the SBA exchange resin is washed with a second aqueous solution of XCl, wherein X is H or an alkali element, wherein the XCl is present in the second aqueous solution in a concentration of 0.01 M to 2 M.

### CROSS-REFERENCE TO RELATED APPLICATIONS

The present application claims benefit of U.S. Provisional Application No. 63/779,732 filed Mar. 28, 2025, all of the contents of which are incorporated herein by reference.

### STATEMENT REGARDING FEDERALLY SPONSORED RESEARCH

This invention was made with government support under Prime Contract No. DE-AC05-00OR22725 awarded by the U.S. Department of Energy. The government has certain rights in the invention.

### FIELD OF THE INVENTION

The present invention generally relates to methods for regenerating anion exchange resins, more particularly strong-base anion (SBA) exchange resins, and more particularly anion-exchange resins that are used in industrial wastewater treatment.

### BACKGROUND

Anion-exchange resins are often used for wastewater treatment and product recovery processes. The anion-exchange resin works by removing anions from aqueous solutions. After the anion-exchange resin is used to capture pollutants or valuable species, it is typically regenerated to permit a cyclic separation process. When the anionic species are in a simple simulated solution, resin regeneration using conventional washing solutions, such as NaCl, HCl, or NaOH aqueous solutions, is generally straightforward. However, when the anions of interest are part of a complex solution that contains a plethora of species, such as found in groundwater leachate of fly ash at coal power-plant sites or other industrial waste streams, resin regeneration with a conventional washing solution becomes a significant challenge. Thus, particularly in the case of anion-exchange resins that have been used for industrial wastewater treatment, there would be a significant benefit in a method that could more effectively and economically regenerate the anion-exchange resin.

### SUMMARY

The present disclosure is directed to a method for regenerating anion-exchange resins, and more particularly, strong-base anion (SBA) exchange resins. The SBA exchange resin typically contains quaternary ammonium groups. The method can advantageously remove a host of anionic species from SBA exchange resins, including particularly tenacious anions often found in industrial wastewater, such as sulfate, sulfite, selenate, and selenite species and mixtures thereof. Moreover, the method advantageously achieves this in a straightforward and cost-effective manner.

The method more specifically entails the following steps: (i) a first washing step in which the SBA exchange resin is washed with a first aqueous solution of a salt containing a divalent or trivalent anion, wherein the salt is present in the first aqueous solution in a concentration of at least 0.001 M and up to the solubility limit of the salt; and (ii) a second washing step in which the SBA exchange resin is washed with a second aqueous solution of XY, wherein X is H or an alkali element and Y is Cl⁻ or NO₃⁻, wherein XY is present in the second aqueous solution in a concentration of 0.01 M to 2 M.

As further discussed below, the present work demonstrates that while conventional regeneration with sodium chloride (NaCl) is effective for simulated wastewater, with ca. 80% efficiency, NaCl fails to regenerate resin loaded with real industrial wastewater, achieving less than 20% efficiency. To overcome this challenge, a two-step regeneration process was investigated using a sodium carbonate (Na₂CO₃) solution for elution, followed by a NaCl or HCl solution for restoration. Compared to the one-step NaCl regeneration process, the integrated process described herein restored more than 80% of the resin's capacity with real industrial wastewater. Beyond demonstrating regeneration performance, the present work elucidates fundamental mechanisms of the observed regeneration behavior across different water matrices and experimental conditions. Particularly, accounting for pH-dependent carbonate speciation, it is proposed that the first washing/elution step using a divalent or trivalent anion exploits the resin's strong affinity for higher valence anions to displace strongly bound contaminants, while the subsequent restoration step relies mainly on the mass action effects of chloride or nitrate ions to regenerate the resin sites. The protocol was optimized to achieve rapid regeneration (typically, less than 10 minutes) using moderate chemical concentrations (0.5 M) of carbonate or other divalent anion species in treating real leachate. In batch cyclic experiments, selenium (Se) regeneration reached nearly complete recovery after five consecutive sorption and desorption cycles, while in the fixed-bed system, the regeneration efficiency remained at approximately 80% after five cycles.

### BRIEF DESCRIPTION OF THE DRAWINGS

FIGS. 1a-1b. Graphs showing regeneration efficiency of IRA-900 SBA anion exchange resin for selenium (FIG. 1a) and sulfur (FIG. 1b) as a function of conventional regeneration agent type and concentration. Pristine resin (5 g) was first contacted with 100 mL of simulated leachate (120 ppb of Se in SeO₄²⁻, 840 ppm of S in SO₄²⁻) for 24 hours. The loaded resin was then regenerated with 10 mL of HCl, NaCl, or NaOH (conventional regeneration agents) at the specified concentrations for 24 hours.

FIGS. 2a-2b. Graphs showing desorption kinetics of Se (FIG. 2a) and S (FIG. 2b) from 5 g IRA-900 resin loaded with 100 mL of simulated leachate containing 120 ppb Se in SeO₄²⁻ and 840 ppm S in SO₄²⁻ using 10 mL of 0.5 M NaCl regeneration solution at 20° C. The experiments were conducted over a 60-minute period under two distinct conditions, with a constant 160-rpm agitation and without agitation, to assess the effect of external mass transfer on the desorption rate.

FIGS. 3a-3b. Graphs showing sorption capacity (q_{col}) for Se (FIG. 3a) and S (FIG. 3b) calculated after 600 mL of solution passed through the smaller column (diameter of 2.3 cm, height of 15 cm, packed with 30 g IRA-900) at a flow rate of 2.5 mL/min for each of five consecutive operational cycles. Each cycle consisted of loading simulated leachate (120 ppb of Se in SeO₄²⁻, 840 ppm of S in SO₄²⁻) onto a fixed-bed column containing 30 g of IRA-900, followed by in-column regeneration with 100 mL of 0.5 M NaCl solution at the same flow rate.

FIGS. 4a-4b. Graphs showing regeneration efficiency of IRA-900 for Se (FIG. 4a) and S (FIG. 4b) after the resin was contacted with real industrial leachate following treatment with BBIG (13 ppb Se, 8 ppm S). The resin was loaded in batch mode at a dosage of 50 g/L (5 g resin in 100 mL of BBIG-treated leachate) for 24 hours at 20° C. The loaded resin was then regenerated using NaCl at concentrations of 0.5 M, 1 M, and 2 M at temperatures of 20° C., 35° C., and 50° C.

FIG. 5. Graph showing comparison of the two-step regeneration protocols for IRA-900 resin loaded with BBIG-treated leachate (containing 26 ppb Se and 138 ppm S) at a dosage of 20 g/L. The protocols consisted of a 24-hour treatment with 10 mL of 2 M Na₂CO₃, followed by a 24-hour regeneration with either 10 mL of 1 M HCl or 1 M NaCl, both conducted at 20° C. with 160 rpm agitation.

FIGS. 6a-6b. Graphs showing desorption kinetics of Se (FIG. 6a) and S (FIG. 6b) from 2 g IRA-900 resin loaded with 100 mL of BBIG-treated leachate containing 14 ppb Se and 155 ppm S using 10 mL of 2 M Na₂CO₃ solution at 20° C. The graphs show the concentration of each anion in the 2 M Na₂CO₃ eluate over a six-hour period.

FIG. 7. Graph showing regeneration efficiency for Se and S as a function of the second-step NaCl contact time. Resin loaded with BBIG-treated leachate, containing 15 ppb Se and 44 ppm S, was first subjected to a 10-minute wash with 2 M Na₂CO₃. The resin was then restored with 1 M NaCl for durations varying between 3 and 30 minutes.

FIG. 8. Graph showing optimization of the Na₂CO₃ concentration used in the elution process. Resin loaded with raw leachate containing 96 ppb Se and 664 ppm S was regenerated using Na₂CO₃ at concentrations varying between 0.01 M and 2 M, followed by a uniform Cl⁻ restoration step with 1 M NaCl solution. The regeneration efficiency was determined based on the resin's sorption capacity in the subsequent sorption cycle.

FIG. 9. Graph showing optimization of the NaCl concentration used in the regeneration process. Resin loaded with BBIG-treated leachate, containing 18.5 ppb Se and 1.4 ppm S, was first washed with a uniform 0.5 M Na₂CO₃, followed by a NaCl restoration step at concentrations varying between 0.01 M and 2 M. The regeneration efficiency was evaluated based on the resin's sorption capacity in the subsequent sorption cycle.

FIGS. 10a-10b. Graphs showing equilibrium capacity (qₑ) for Se (FIG. 10a) and S (FIG. 10b) over five consecutive batch cycles using BBIG-treated leachate. In each cycle, 10 g of IRA-900 were contacted with 100 mL of BBIG-treated leachate containing approximately 17.4 ppb Se and 44.7 ppm S. After each loading phase, the resin was regenerated using the two-step sequence of a 10 mL of 0.5 M Na₂CO₃ wash followed by another 10 mL of 0.5 M NaCl wash.

FIGS. 11a-11b. Graphs showing sorption capacity (q_{col}) for Se (FIG. 11a) and S (FIG. 11b) over five consecutive fixed-bed-column cycles using BBIG-treated leachate, containing 15 ppb Se and 125.7 ppm S. Each cycle consisted of a fixed treated volume of 2100 mL at a flow rate of 10 mL/min, followed by in-column regeneration using the optimized two-step protocol, i.e., 10-minute static holds with two bed volumes of 0.5 M Na₂CO₃ and 0.5 M NaCl twice.

### DETAILED DESCRIPTION

The method described herein is directed to the regeneration of strong-base anion (SBA) exchange resins, particularly SBA exchange resins that are used in the processing of wastewater, which may be industrial or municipal wastewater. As well known in the art, SBA resin typically contains quaternary ammonium groups as the active anion exchanging functional groups. In some embodiments, the quaternary ammonium groups are (or include) trimethyl ammonium groups. In other embodiments, the quaternary ammonium groups are (or include) dimethyl ethanolammonium groups. In other embodiments, the quaternary ammonium groups are or include N-alkylated heterocyclic groups, such as N-alkylpyridinium and alkylated imidazolium groups. The SBA resin may also include a combination of two or more types of ammonium groups which may be from among any of those provided above. In some embodiments, the ammonium groups are quaternary alkyl ammonium groups containing long-chain alkyl groups with at least 6, 7, 8, 9, 10, 11, or 12 carbon atoms, such as octyl, decyl, or dodecyl groups.

The quaternary ammonium groups may be covalently or non-covalently bonded to a matrix or support. In some embodiments, the matrix or support in the SBA exchange resin is crosslinked with divinylbenzene (DVB). In other embodiments, the matrix or support in the SBA exchange resin contains a copolymeric styrene-divinylbenzene crosslinked scaffold in which the quaternary ammonium groups are embedded (e.g., a macroporous styrene-DVB support). In some embodiments, the SBA exchange resin contains a non-polar acrylic ester polymer (typically as inert beads) impregnated with the liquid resin extractant. In the latter type of impregnated system, the functional groups are in liquid form rather than fixed to a polymer backbone (as with IX resins), which provides the liquid anion exchanger with greater flexibility to coordinate with target anions. In other embodiments, the SBA exchange resin may be a macroporous polyvinylpyridine resin, which may be a copolymer of 1-methyl-4-vinylpyridine and divinylbenzene.

After the SBA exchange resin has been used for treating aqueous wastewater, the presently described method regenerates the SBA exchange resin in two washing steps, as follows:

In a first washing step, the SBA exchange resin is washed with a first aqueous solution of a salt containing a divalent or trivalent anion. Some examples of divalent anions include carbonate (CO₃²⁻), hydrogen phosphate (HPO₄²⁻), and oxalate. Alkali metal salts of the divalent anions are considered herein, such as Li₂CO₃, Na₂CO₃, K₂CO₃, Na₂HPO₄, and K₂HPO₄. Some examples of trivalent anions include phosphate (PO₄³⁻) and borate (BO₃³⁻). Alkali metal salts of the trivalent anions are considered herein, such as Na₃PO₄, K₃PO₄, and Na₃BO₃. The salt is present in the first aqueous solution in a concentration of at least 0.001 M and up to the solubility limit of the salt. The solubility limit of the salt may be about or at least, for example, 2 M, 2.5 M, or 3 M. In some embodiments, the maximum concentration employed, even if below the highest possible concentration, is selected as 2 M, 2.5 M, or 3 M. In various embodiments, the concentration of the salt in the first aqueous solution is precisely, about, or at least, for example, 0.001 M, 0.01 M, 0.1 M, 0.2 M, 0.5 M, 1 M, 1.5 M, 2 M, 2.5 M, or 3 M, or the concentration is within a range bounded by any two of the foregoing concentrations, e.g., 0.001-3 M, 0.001-2.5 M, 0.001-2 M, 0.001-1.5 M, 0.001-1 M, 0.001-0.5 M, 0.01-3 M, 0.01-2.5 M, 0.01-2 M, 0.01-1.5 M, 0.01-1 M, 0.01-0.5 M, 0.1-3 M, 0.1-2.5 M, 0.1-2 M, 0.1-1.5 M, 0.1-1 M, 0.1-0.5 M, 0.25-3 M, 0.25-2.5 M, 0.25-2 M, 0.25-1.5 M, 0.25-1 M, 0.5-3 M, 0.5-2.5 M, 0.5-2 M, 0.5-1.5 M, 0.5-1 M, 1-3 M, 1-2.5 M, 1-2 M, or 1-1.5 M. In some embodiments of the first washing step, the SBA exchange resin is washed with the first aqueous solution in a vessel before being filtered and before proceeding to the second washing step. In other embodiments of the first washing step, the SBA exchange resin is contained within a column, and the first washing solution is eluted through the column to wash the resin. The column or vessel used in the first washing step may be the same column or vessel in which the SBA exchange resin was used or will be used for treating wastewater.

In some embodiments, the first washing step is conducted at a temperature at or around room temperature, such as a temperature of 20-30° C. or more particularly about 25° C. In other embodiments, the first washing step is conducted at an elevated temperature, i.e., at or above 30° C. and up to, for example, 35° C., 40° C., 45° C., 50° C., 55° C., or 60° C. The temperature of the first washing step may alternatively be within a range bounded by any two of the foregoing temperatures, e.g., 20-60° C., 30-60° C., 35-60° C., 40-60° C., 45-60° C., 50-60° C., 20-50° C., 30-50° C., 35-50° C., 40-50° C., 20-40° C., 30-40° C., or 35-40° C.

In a second (subsequent) washing step, the SBA exchange resin is washed with a second aqueous solution containing XY, wherein X is H or an alkali element and Y is Cl⁻ or NO₃⁻. In some embodiments, the second aqueous solution is a solution of HCl (hydrochloric acid) or HNO₃ (nitric acid) while in other embodiments the second aqueous solution is a solution containing an alkali metal chloride or alkali metal nitrate. Some examples of alkali metal chlorides include LiCl, NaCl, and KCl. Some examples of alkali metal nitrates include LiNO₃, NaNO₃, and KNO₃. The XY species is present in the second aqueous solution in a concentration of 0.01 M to 2 M. In various embodiments, the concentration of the XY species in the second aqueous solution is precisely, about, or at least, for example, 0.01 M, 0.1 M, 0.2 M, 0.5 M, 1 M, 1.5 M, or 2 M, or the concentration is within a range bounded by any two of the foregoing concentrations, e.g., 0.01-2 M, 0.01-1.5 M, 0.01-1 M, 0.01-0.5 M, 0.01-0.2 M, 0.1-2 M, 0.1-1.5 M, 0.1-1 M, 0.1-0.5 M, 0.25-2 M, 0.25-1.5 M, 0.25-1 M, 0.25-0.5 M, 0.5-2 M, 0.5-1.5 M, 0.5-1 M, 1-2 M, or 1-1.5 M. In some embodiments of the second washing step, the SBA exchange resin is washed in a vessel with the second aqueous solution before being filtered. In other embodiments of the second washing step, the SBA exchange resin is contained within a column, and the second washing solution is eluted through the column to wash the resin. The column or vessel used in the second washing step may be the same column or vessel in which the SBA exchange resin was used or will be used for treating wastewater. In further or separate embodiments, the column or vessel used in the second washing step may be the same column or vessel in which the first washing step was conducted. In some embodiments, the SBA exchange resin is contained within a column during both first and second washing steps, i.e., the first and second washing steps are conducted by eluting first and second aqueous solutions, respectively, through the column. In separate or further embodiments, after the second washing step, the SBA exchange resin is rinsed with DI water.

In some embodiments, the second washing step is conducted at a temperature at or around room temperature, such as a temperature of 20-30° C. or more particularly about 25° C. In other embodiments, the second washing step is conducted at an elevated temperature, i.e., at or above 30° C. and up to, for example, 35° C., 40° C., 45° C., 50° C., 55° C., or 60° C. The temperature of the second washing step may alternatively be within a range bounded by any two of the foregoing temperatures, e.g., 20-60° C., 30-60° C., 35-60° C., 40-60° C., 45-60° C., 50-60° C., 20-50° C., 30-50° C., 35-50° C., 40-50° C., 20-40° C., 30-40° C., or 35-40° C.

The SBA resin, before being regenerated by the above-described process, is typically used for treating wastewater, such as municipal or industrial wastewater. Thus, the resin before regeneration will typically contain adsorbed (residual) anions from the wastewater. These adsorbed anions are removed and ultimately replaced by chloride ion upon completion of the above-described washing steps. In some embodiments, the SBA resin, before being regenerated, contains a wide mixture of various types of adsorbed anions. In some embodiments, the SBA resin, before regeneration, contains one or more residual anions selected from any of the following species: sulfate (SO₄²⁻), sulfite (SO₃²⁻), selenate (SeO₄²⁻), selenite (SeO₃²⁻), tellurate (TeO₄²⁻), chromate (CrO₄²⁻), molybdate (MoO₄²⁻), and tungstate (WO₄²⁻). In further or separate embodiments, the resin, before regeneration, contains one or more residual anions that contain at least one element having an atomic number greater than 20. Such anions are typically oxide-containing anions, such as those exemplified above. Some examples of elements having an atomic number greater than 20 include the transition, lanthanide, and actinide metals. As well known, the transition metals generally refer to the elements of Groups 3-12 of the Periodic Table, the lanthanide elements refer to elements of Groups 57-71 of the Periodic Table, and the actinide elements refer to elements of Groups 89-103 of the Periodic Table.

Examples have been set forth below for the purpose of illustration and to describe certain specific embodiments of the invention. However, the scope of this invention is not to be in any way limited by the examples set forth herein.

### EXAMPLES

### Overview

The present work demonstrates an effective regeneration process for Se removal using SBA resins in chloride form, with IRA-900 as a representative commercial SBA resin, particularly under real-world wastewater treatment conditions. Initial experiments began by directly comparing the efficacy of a conventional regeneration protocol on resin loaded with both simulated and real industrial wastewaters to quantitatively assess the impact of a complex matrix. Subsequent experiments systematically investigated an integrated two-stage regeneration process using CO₃²⁻ of a Na₂CO₃ solution for elution followed by a polishing regeneration step (NaCl/HCl) for restoration of Cl⁻ in the resin. The observed regeneration performance was interpreted mechanistically by considering pH-dependent carbonate speciation, the resin's preference for higher-valence ions, and the concentration-driven mass action governing displacement of anions. The new protocol was then systematically optimized by examining key parameters including regeneration agent concentrations and contact times through detailed batch experiments. Finally, the long-term stability and reusability of the optimized protocol were evaluated through multi-cycle sorption-desorption studies to confirm its viability for practical, large-scale implementation. Beyond demonstrating regeneration performance, the present work also investigates the fundamental mechanisms at work in the observed regeneration behavior across different water matrices and experimental conditions.

### Materials and Methods

A commercial SBA exchange resin, Amberlite® IRA-900 (chloride form), was used in this study. The resin contains a macroporous styrene-divinylbenzene matrix functionalized with trimethyl ammonium groups. The resin contains particles having a particle size distribution of 640-800 μm. The resin has a water content of 60%.

All synthesized aqueous solutions were prepared with ultrapure Milli-Q water (18 MΩ·cm) with analytical grade chemical reagents. Simulated wastewater was formulated by dissolving specific amounts of sodium selenate (Na₂SeO₄) and potassium sulfate (K₂SO₄) to achieve target concentrations of SeO₄²⁻ and SO₄²⁻, respectively. The elution/regeneration solutions were prepared from sodium carbonate monohydrate (Na₂CO₃·H₂O), NaCl powder, NaOH powder, and a 1 N HCl stock solution.

The real wastewater used in this study was obtained from leachate collection systems of compacted fly ash located at the Bull Run Fossil Plant of the Tennessee Valley Authority (TVA), an 889 MW coal-fired power station, and was collected using a battery-powered pump. This water is characterized by a significant disparity in anion concentrations, with total S (~20-60 mM) being 20000-40000 times more abundant than total Se (~1.5-2.5 μM). The leachate matrix also contained additional dissolved species beyond Se and S. Following co-crystallization with benzene-bis-iminoguanidinium (BBIG), a pre-treatment approach previously developed, the Se concentration was reduced to approximately 0.19 μM (15 ppb), while the S concentration decreased to approximately 0.2 mM (8 ppm). It should be noted that the compositions and the concentration of the species in raw real leachate and BBIG-treated leachate varied depending on the sample collection sites and conditions.

### Preliminary Fixed-Bed Screening for Selenium Removal

Prior to regeneration testing, a series of preliminary fixed-bed column experiments were conducted to evaluate the selenium removal performance of the IRA-900 resin with different water matrices. The experiments were performed at 20° C. using a glass column (2.3 cm in inner diameter and 15 cm in length) packed with 180 g of IRA-900 resin, with a peristaltic pump controlling the flow. The water matrices included (i) simulated leachate containing 120 ppb Se (as SeO₄²⁻) and 1856 ppm S (as SO₄²⁻) at a flow rate of 2.5 mL/min, (ii) raw industrial leachate with 125 ppb Se and 1875 ppm S, also treated at a flow rate of 2.5 mL/min, and (iii) BBIG-treated leachate with 13 ppb Se and 7 ppm S, which was tested under field conditions at a flow rate of 47.5 mL/min. The removal performance within the first 600 mL of treated effluent was analyzed for all cases.

Regeneration of IRA-900 after Loading with Simulated Wastewater

Initial sorption and regeneration studies were conducted in batch mode using simulated leachate containing fixed concentrations of 120 ppb Se as SeO₄²⁻ and 840 ppm S as SO₄²⁻, based on the representative composition of the real leachate at the time of sampling. It should be noted that all sorption and regeneration experiments in batch mode were conducted at a constant temperature of 20° C. using a commercial shaker operated at 160 rpm to ensure complete and continuous mixing of the resin beads and solution, unless otherwise specified. In the sorption phase, 5 g of resin beads were contacted with 100 mL of the simulated wastewater for 24 hours.

To screen potential regeneration agents, the loaded resin was subsequently immersed in 10 mL solutions of NaCl, HCl, or NaOH, each prepared at three concentrations of 0.05 M, 0.1 M, and 0.5 M, for 24 hours. Each set of regenerated resins was used to treat the simulant under the same conditions to evaluate the regeneration efficiency. In parallel, a separate batch test was conducted to examine the desorption kinetics: the sorption step was performed with the same procedure described above, while the subsequent regeneration was performed using 10 mL of 0.5 M NaCl solution with and without agitation. Samples were periodically collected within a 60-minute period to monitor the desorption progress.

In addition to batch mode, fixed-bed experiments were performed to evaluate resin reusability over five cycles. In these tests, 30 g of IRA-900 resin were packed in a cylindrical column (2.3 cm in inner diameter and 15 cm in length), with a peristaltic pump controlling the flow. Each cycle started with a 240-minute loading phase, where simulated leachate was introduced at a flow rate of 2.5 mL/min and followed by a regeneration phase using 100 mL of 1 M NaCl at the same flow rate. After each sorption-regeneration cycle, the column was washed with 100 mL of deionized (DI) water at a flow rate of 10 mL/min and then fully drained before the next loading phase began.

Regeneration of IRA-900 after Loading with Real Wastewater

A one-step regeneration test using the BBIG-treated leachate effluent was initiated. At the sorption phase, 5 g of IRA-900 resin beads were contacted with 100 mL of this solution for a 24-hour period at 20° C. and 160 rpm agitation rate. Following sorption, a screening process was initiated to assess the performance of NaCl, HCl, and NaOH as potential regeneration agents. For each set of tests, 5 g of loaded resin was submerged in one of the regeneration agents at concentrations of 0.5 M, 1 M, and 2 M for 24 hours. To investigate the effect of temperature on regeneration efficiency, these screening tests were performed at three distinct temperatures: 20, 35, and 50° C. The recovered resin was reused in a replicate batch experiment under the same experimental conditions.

Insights from the one-step screening tests guided the design of an advanced regeneration approach. Regeneration agents were combined into a two-step process that permitted efficient desorption and restored the resin to its original chloride form. The novel two-step regeneration method was initially investigated using resin that had been used to treat real leachate in batch mode. For the sorption phase, a mass of 2 g of IRA-900 resin was first submerged in 100 mL of BBIG-treated leachate for 24 hours. The loaded resin was then treated with a 2 M Na₂CO₃ solution for 24 hours. After being filtered, the resin was subsequently treated for an additional 24 hours with 10 mL of either 1 M NaCl or 1 M HCl solution. Both steps of the regeneration process were performed under constant temperature at 20° C. and agitation at 160 rpm to ensure thorough mixing. The resin, once regenerated, was tested again for sorption under the same conditions.

The desorption kinetics of this two-step regeneration process was investigated in batch mode. To first determine the desorption rate of the Na₂CO₃ step, 2 g of IRA-900 resin was loaded by contacting it with 100 mL of BBIG-treated leachate. The loaded resin was then regenerated sequentially, first with 10 mL of 2 M Na₂CO₃ and subsequently with 10 mL of 1 M NaCl. Samples were periodically collected from the Na₂CO₃ solution over the first six hours of this regeneration process and analyzed for Se and S concentrations. In a separate experiment designed to optimize the effect of contact time for the NaCl restoration step, seven identical batches were prepared by loading 2 g of IRA-900 resin with 100 mL of BBIG-treated leachate for 24 hours. All seven batches of loaded resin were first treated with 10 mL of 2 M Na₂CO₃ for a fixed duration of 10 minutes. Following this step, each batch was treated with 10 mL of 1 M NaCl for a specific contact time, ranging from 3 to 30 minutes, to determine the influence of the contact time of this step on the overall regeneration efficiency. After regeneration, the resin was reused for another sorption test under the same batch conditions.

To further optimize the integrated regeneration process, a subsequent experiment was designed to determine the optimal CO₃²⁻ and Cl⁻ concentrations. During the sorption stage, multiple identical batches were prepared by loading 2 g of IRA-900 resin with 100 mL of either raw leachate or BBIG-treated leachate for 24 hours. For the determination of the optimal concentration of Na₂CO₃, each batch was treated with a 10 mL solution, with Na₂CO₃ ranging from 0.01 M to 2 M, for 10 minutes. Following the Na₂CO₃ treatment, all batches were then subjected to the same additional regeneration step using 10 mL of 1 M NaCl for another 10 minutes. To determine the optimal NaCl concentration in the restoration step, a separate experiment was subsequently performed under identical loading conditions. In the elution step, 0.5 M Na₂CO₃ (which was determined to be the optimal concentration) was applied for all batches. Subsequently, the resins were restored with NaCl at concentrations ranging from 0.01 M to 2 M for 10 minutes. After Na₂CO₃ and NaCl concentrations were optimized, a duplicate sorption experiment was conducted using the treated resin to evaluate its recovered performance, respectively.

Resin reusability using the presently described two-step regeneration method was first evaluated through a five-cycle batch study. For each cycle, 10 g of the same IRA-900 was contacted with 100 mL of the same batch of BBIG-treated leachate for 24 hours. Samples were collected from the treated solution to analyze the resin performance. After each loading stage, the resin was regenerated by the two-step sequential process using 10 mL of 0.5 M Na₂CO₃ solution first, followed by 10 mL of 0.5 M NaCl solution, with each step lasting 10 minutes. The regenerated resins were used for the loading phase of the subsequent cycle.

The long-term stability and performance of the resin were also evaluated using a five-cycle fixed-bed column study. The same column (2.3 cm in inner diameter and 15 cm in length) used for the simulated wastewater was packed with 30 g of pristine IRA-900 resin. During the loading phase, BBIG-treated leachate was passed through the column at a continuous flow rate of 10 mL/min for 210 minutes using a peristaltic pump, corresponding to an empty bed contact time of 6 minutes, calculated as the bed volume divided by the volumetric flow rate. This contact time is on a minute scale and is consistent with typical fixed-bed anion exchange. Following loading, the two-step regeneration procedure was performed by first filling up the column with 75 mL (one packed bed volume) of 0.5 M Na₂CO₃ solution for 10 minutes. The solution was drained out, and the column was loaded with another 75 mL of 0.5 M Na₂CO₃ solution to ensure a complete washing. Immediately following that, the column was restored with 75 mL of 0.5 M NaCl solution for 10 minutes, which was also repeated twice. Before the subsequent cycles commenced, the column was rinsed with 200 mL of DI water to remove any residual regeneration solution. This entire sequence was repeated for a total of five cycles at room temperature (about 20° C.). During each cycle of experiments, samples were collected at fixed time intervals to analyze the resin performance.

### Analytical Methods

To prepare samples for analysis, liquid aliquots were first filtered from each experiment through a 0.02-μm syringe filter to remove any suspended solids. The resulting filtrate samples were then diluted with a 2% nitric acid (HNO₃) solution. Following sample preparation, the concentrations of various elements were measured using inductively coupled plasma mass spectroscopy (ICP-MS) equipped with a sampling and autodilution system.

### Analysis of Experimental Data

In batch experiments, the oxyanion equilibrium capacity qₑ of IRA-900 resin was calculated by Equation 1, the removal efficiency was calculated by Equation 2, and the regeneration efficiency was determined from Equation 3.

$${q}_{e} = \frac{( {C}_{0} - {C}_{e} ) V}{W} , \qquad ( 1 )$$

$$Removal efficiency = \frac{{C}_{0} - {C}_{e}}{{C}_{0}} \qquad ( 2 )$$

where qₑ is the sorption capacity at equilibrium; Co is the initial oxyanion concentration of the solution; Cₑ is the oxyanion concentration at equilibrium; W is the resin mass, g; V is the volume of the solution, L; q₀ is the equilibrium capacity of pristine resin; qᵣ is the equilibrium capacity after regeneration. Throughout this work, resin sorption capacities are expressed in units of either mg/g or ug/g, while aqueous solution concentrations are reported in units of mM, μM, ppm, or ppb, as appropriate for the specific measurement and context.

In fixed-bed experiments, the oxyanion sorption capacity of IRA-900 resin was calculated by Equation 4, as follows:

$${q}_{col} = \frac{( {C}_{in} - {C}_{out} ) {V}_{t}}{W} \qquad ( 4 )$$

where q_{col} is the sorption capacity from the fixed-bed experiments; Cᵢₙ is the feed solution (inlet) concentration; Cₒᵤₜ is the accumulated final (outlet) concentration at equilibrium; W is the resin mass packed in the fixed-bed column, g; and Vt is the total volume of the solution passed through the fixed-bed column, L.

### Results and Discussion

Se Removal from Different Water Matrices Using IRA-900 Resin in Fixed-Bed Mode

Prior to regeneration testing, a preliminary column screening was conducted to evaluate the selenium removal ability of IRA-900 resin from different water matrices. These tests were conducted exclusively in fixed-bed mode, as it provides a more practical representation of real treatment conditions. Batch experiments elsewhere in this study were performed only as initial attempts to provide an understanding of the fundamental ion-exchange behavior and kinetics. The resin achieved 99.6% Se removal from simulated leachate and maintained 88.4% efficiency in raw leachate despite the presence of abundant competing anions. After BBIG-treatment of the raw leachate, the removal efficiency increased to 96.6%. These findings serve as preliminary evidence supporting the selection of IRA-900 resin for Se removal in real wastewaters.

I. Regeneration of IRA-900 Used with Simulated Wastewater
I-1) Batch Regeneration Studies with the Conventional One-Step Approach

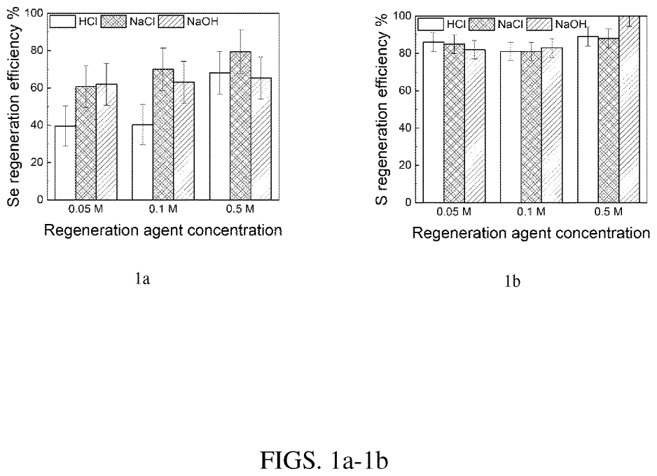

Before studying regeneration in a complex real wastewater system, it is essential to first determine the optimal regeneration agent by examining the regeneration efficiency of IRA-900 resin for both the target contaminant, Se oxyanions in SeO₄²⁻, and the major competing ion, SO₄²⁻, in simulated wastewater. Three regeneration agents (HCl, NaCl, and NaOH) were evaluated at concentrations of 0.05 M, 0.1 M, and 0.5 M with regeneration efficiencies presented in FIG. 1.

For Se (FIG. 1a), a clear increase in regeneration efficiency was observed with increasing regeneration agent concentration. Notably, 0.5 M NaCl proved most effective, achieving a 79.4% Se recovery that surpassed both 0.5 M HCl (68.2%) and 0.5 M NaOH (65.4%). This highlights the efficacy of a high Cl⁻ concentration in driving the desorption of SeO₄²⁻ from the resin's functional sites via a strong mass action effect. In contrast, S reached 100% regeneration with 0.5 M NaOH, while Se regeneration reached only 65.4% under the same conditions. This observation indicates that regeneration performance is species dependent under the conditions evaluated, and a regeneration agent that is effective for one species may not be equally effective for another. Additionally, S desorption was markedly more efficient across all test conditions (FIG. 1b) than Se regeneration (FIG. 1a), as indicated by a direct comparison of the two profiles, suggesting that S more readily desorbs from IRA-900 than Se. This behavior is a direct consequence of the resin's known higher intrinsic affinity for SeO₄²⁻ over SO₄²⁻, which makes the displacement of SeO₄²⁻ more challenging and resulting in lower regeneration efficiencies compared to SO₄²⁻ under simulated wastewater conditions. Consequently, 0.5 M NaCl was selected for subsequent tests because Se is the target contaminant and it provided the highest Se regeneration among the conditions evaluated. In addition, NaCl offers practical advantages including lower cost, neutral pH operation, and enhanced operational safety, even though 0.5 M NaOH fully restored the S-loaded resin.

I-2) Batch Desorption Kinetic Studies with the Conventional One-Step Regeneration

After NaCl was selected as the best regeneration agent, desorption kinetic studies were conducted to determine the contact time and to elucidate the rate-controlling mass transfer mechanisms. The desorption of Se and S from loaded IRA-900 beads was monitored over a 60-minute period using 0.5 M NaCl solutions, with and without agitation.

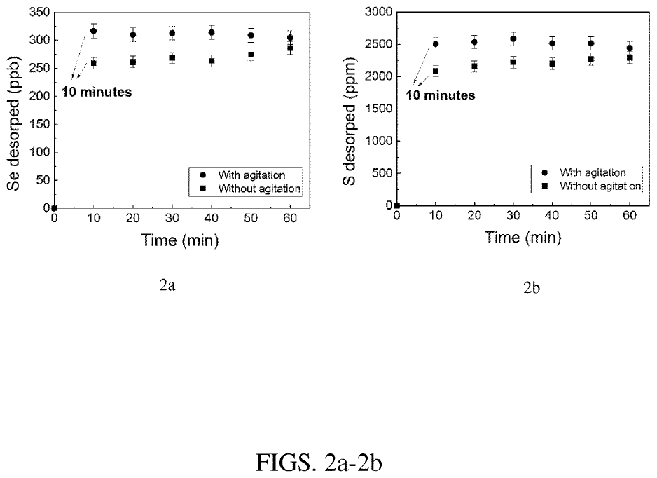

The kinetic profiles for Se and S desorption are presented in FIGS. 2a and 2b. The data revealed that the regeneration process is rapid for both anions, reaching equilibrium within 10 minutes of contact under all conditions tested. In addition, mechanical agitation enhanced the desorption marginally. Since agitation primarily accelerates mass transfer across the external liquid-film boundary layer, its negligible impact on the overall desorption rate indicates that the process is likely governed by an internal mass transfer mechanism, namely intraparticle diffusion within the resin's porous matrix. Furthermore, FIGS. 2a and 2b show that both conditions (with and without agitation) ultimately converged at a similar desorption level. This is because agitation affects only the mass-transfer rate and not the equilibrium behavior of the system.

These kinetic findings have significant practical implications for process design. The rapid kinetics suggest that very short contact times are sufficient for effective regeneration, allowing for reduced downtime and higher process throughput in a scaled-up system. Furthermore, the minimal influence of mixing validates the feasibility of employing simple, non-agitated systems, such as in situ regeneration within a fixed-bed column. This simplifies the process equipment, reduces operational complexity, and enhances the overall scalability of the treatment process.

I-3) Cyclic Study in Fixed-Bed Columns with the Conventional One-Step Regeneration

In this part of the study, an in-column resin regeneration was investigated for long-term stability and reusability of the IRA-900 resin in a fixed-bed column. The column was first operated with simulated leachate for resin loading, followed by in-column regeneration with a 0.5 M NaCl solution. The sorption-regeneration cycles were repeated five times.

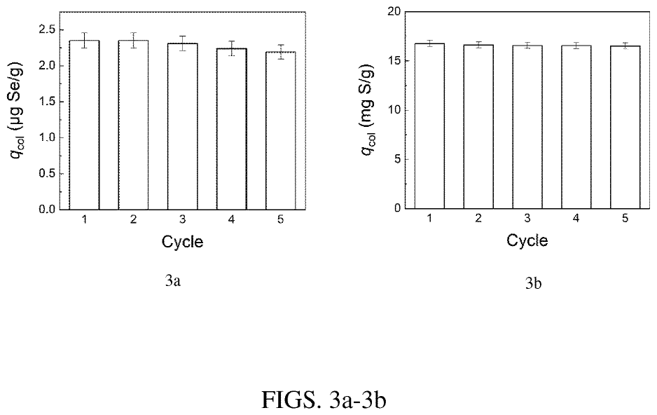

To provide a rigorous, quantitative analysis, the sorption capacity for both Se and S was calculated for each cycle after processing a fixed 600 mL volume of simulated leachate, using the influent concentration and the cumulative effluent concentration. The quantitative performance of the resin over these five cycles is summarized in FIGS. 3a and 3b.

The sorption capacities for both Se (FIG. 3a) and S (FIG. 3b) were calculated according to Equation 4, using the feed solution concentration and final accumulated concentration for each cycle. The marginal standard deviation across five cycles suggests that the resin kept its performance after five cycles. Furthermore, relative to the pristine resin in the first cycle, the regenerated resin retained approximately 93.2% of its original Se sorption capacity and 98.5% of its original S sorption capacity in cycle 5. Breakthrough profiles for both Se and S over all five consecutive cycles were also determined. Although column saturation was not reached in every case, the sorption capacity determined for each cycle, together with the breakthrough profiles, clearly demonstrate the promising durability of IRA-900 resin and the effectiveness of in-column NaCl regeneration protocol for repeated use with simulated wastewater.

II. Regeneration of IRA-900 after Loading with Field-Collected Wastewater
II-1) Conventional One-Step Regeneration for IRA-900 Contacted with Real Wastewater

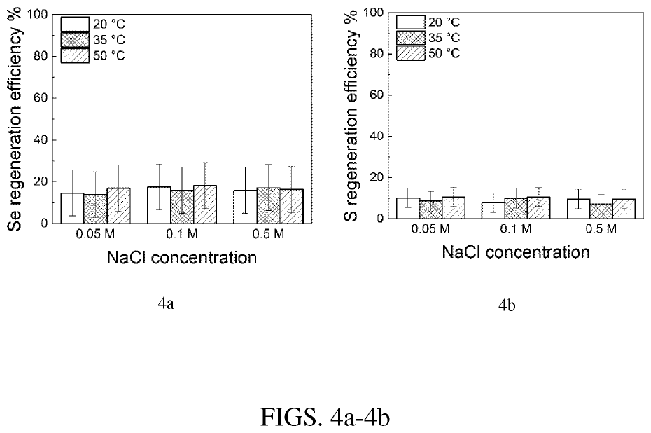

While 0.5 M NaCl was effective for regeneration from the simulated wastewater, its performance with resin exposed to the complex ionic composition of real wastewater was in need of further study. Therefore, a systematic study was conducted by increasing both the NaCl concentration from 0.5 M to 2.0 M and the temperature from 20° C. to 50° C. The overall regeneration efficiencies for Se and S, presented in FIGS. 4a and 4b, quantitatively confirm the inefficacy of this conventional one-step approach. Even under the most aggressive conditions tested, i.e., 2 M NaCl at 50° C., the maximum regeneration efficiency for Se was only 18.2% (FIG. 4a), and the efficiency for S was even lower, never exceeding 12% (FIG. 4b). The data clearly show that neither increasing the NaCl concentration nor elevating the temperature yielded any significant or systematic improvement in performance. The thermodynamic insensitivity to temperature suggests that the ion-exchange process is not strongly entropy-driven. Furthermore, increasing NaCl concentration did not improve regeneration under these one-step regeneration conditions, indicating that chloride mass action alone is insufficient for resin loaded in real leachate.

The different outcomes between the simulated and real wastewater experiments point directly to the strong effects of the wastewater's complex composition. While the simulated water contained only SeO₄²⁻ and SO₄²⁻ as the primary anions, the real leachate contained a wide range of additional dissolved species (Table 1, below). ICP-MS analysis before and after IRA-900 resin treatment shows that, in addition to Se and S, several other constituents decreased in concentration, indicating co-sorption by the resin. Notable decreases were observed for boron (B), phosphorus (P), arsenic (As), vanadium (V), and tin (Sn), which can be present in leachate as oxyanion species, such as borate, phosphate, arsenate or arsenite, vanadate, and stannate. ICP-MS, however, reports only total elemental concentrations rather than aqueous speciation or resin-phase identity. Therefore, these results indicate potential contributors but cannot identify which component(s) are primarily responsible for irreversible fouling. It should also be noted that modest decreases were observed for some elements commonly present as cations, but these changes were minor. These water matrix effects can increase the fraction of sorbed multivalent species that are not readily displaced by Cl⁻ alone, thereby demanding a more robust and chemically targeted regeneration strategy. Herein, a two-stage sequential regeneration process is proposed that centers on the use of divalent CO₃²⁻ to displace sorbed oxyanions that are resistant to Cl⁻ exchange.

TABLE 1
Elemental initial concentrations (C₀) in a representative
sample of industrial leachate collected from the TVA Bull
Run Fossil Plant and the corresponding removal percentages
after treatment with IRA-900 provided by ICP-MS.

| Element | C₀ (ppb) | Removal (%) |
|---|---|---|
| Al | 9.68 | 100.0 |
| P | 0.11 | 100.0 |
| As | 0.21 | 100.0 |
| Se | 125 | 99.4 |
| S | 114384 | 99.3 |
| V | 0.49 | 97.9 |
| Sn | 0.50 | 97.3 |
| Cd | 0.25 | 93.6 |
| B | 21344 | 93.1 |
| Tl | 4.47 | 43.9 |
| Pd | 1200.40 | 31.9 |
| Mn | 72.14 | 23.4 |
| Cs | 3.98 | 21.9 |
| Co | 1.13 | 20.2 |
| Mg | 52780 | 18.0 |
| Sr | 1790.19 | 13.3 |
| Ba | 47.19 | 12.9 |
| Rb | 229.51 | 11.7 |
| Si | 1357.85 | 0.0 |
| K | 99576 | 0.0 |
| Ni | 2.03 | 0.0 |
| Zn | 3.05 | 0.0 |
| In | 95.26 | 0.0 |
| Bi | 84.62 | 0.0 |

The data in Table 1 illustrate the chemical complexity of the real wastewater matrix and show that, in addition to Se and S, multiple other constituents decrease after resin contact. Notably, elemental concentrations can vary between collection dates due to operational changes at the plant.

II-2) Two-Step Resin Regeneration Using Na₂CO₃ and NaCl/HCl

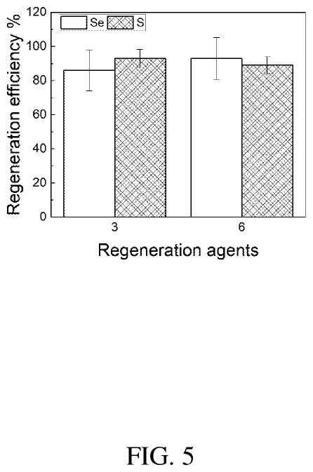

To address the inefficiency in resin regeneration after contact with BBIG-treated wastewater using conventional one-step NaCl solution, a two-step strategy was developed in which Na₂CO₃ was first applied to elute divalent oxyanions, including SeO₄²⁻ and SO₄²⁻, followed by NaCl or HCl regeneration to restore the resin to its chloride form. To validate this strategy, two regeneration protocols were evaluated using IRA-900 resin loaded with real industrial leachate: one with HCl solution and the other with NaCl solution. The corresponding regeneration efficiencies are presented in FIG. 5. Both protocols achieved high regeneration efficiencies for Se and S, each exceeding 85%, which represents a significant improvement compared with the <20% efficiencies observed using the conventional NaCl-alone method. These results clearly demonstrate the effectiveness of the two-step process and confirm that the CO₃²⁻ is more effective in displacing the strongly bound contaminants on the resin owing to its higher affinity for the resin's functional groups.

Additionally, the choice of the Cl⁻ restoration agent had a minor effect on performance, as both NaCl and HCl solutions led to approximately 85% regeneration efficiency. The Na₂CO₃/NaCl protocol, however, was slightly more effective for the target contaminant, Se (93% efficiency), while the Na₂CO₃/HCl protocol performed better for S (93% efficiency). Given that both methods are highly effective and that Se removal is the primary target, the Na₂CO₃+NaCl protocol presents the most sustainable option. It achieves high Se recovery while using a safer, more cost-effective restoration step that also avoids potential damage to the resin typically caused by strong acids. This successful development of a robust regeneration protocol is a critical step toward implementing ion exchange as a viable and sustainable technology for treating complex industrial wastewaters.

### II-3) Optimization of the Kinetics of the Two-Step Regeneration Process

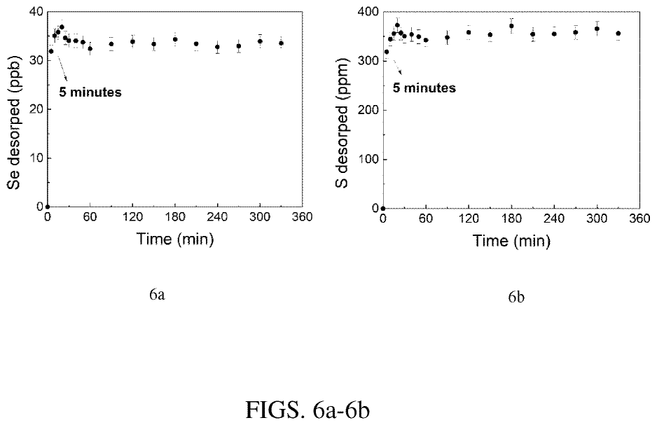

To optimize the two-stage regeneration process, the kinetics of both steps were investigated to define the minimum required contact times. For the first step, resins loaded with BBIG-treated leachate were contacted with 10 mL of a 2 M Na₂CO₃ solution at 160-rpm shaking speed, and the concentrations of desorbed Se and S were monitored over six hours. For both Se (FIG. 6a) and S (FIG. 6b), the eluate concentrations reached a near steady level within 5 minutes, with only minor variation thereafter, while the concentrations remained consistent through 25 minutes, indicating that the ion-exchange process is nearly complete within this short timeframe. This rapid kinetic behavior confirms that the process is compatible with efficient, continuous-flow systems where long residence times are impractical. To further validate the effectiveness of the optimized regeneration strategy under the tested conditions, a final restoration step with 10 mL of 1 M NaCl was performed after the carbonate treatment in this experiment, and the overall Se regeneration efficiency was promising (~88%).

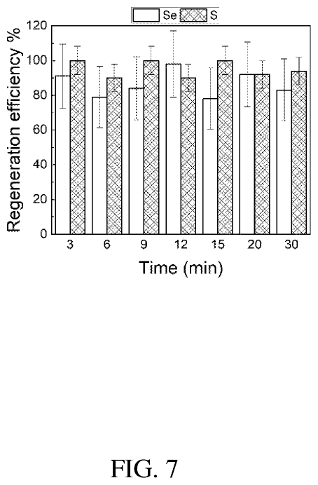

To determine the kinetics of the second regeneration step using NaCl, an alternative experimental approach was employed due to the analytical challenge in directly measuring Cl⁻. Batches of loaded resin with BBIG-treated leachate, containing 15 ppb Se and 44 ppm S, were first treated with 2 M Na₂CO₃ solutions for 10 minutes, respectively. Subsequently, each batch was exposed to a 1 M NaCl solution for varying contact times between 3 and 30 minutes. The overall regeneration efficiency was then determined by assessing the resin's performance in a subsequent identical sorption step. The results, shown in FIG. 7, revealed that regeneration efficiency rapidly reaches a maximum. A contact time of just 3 minutes with the NaCl solution is sufficient to achieve a Se regeneration efficiency of approximately 90%. Extending the resin restoration time beyond this point yields no obvious improvement in the final regeneration efficiency of the resin.

These kinetic data can guide the design of an efficient two-step regeneration protocol: a conservative 5-minute CO₃²⁻ wash followed by a 3-minute Cl⁻ contact time is sufficient to restore the resin for cyclic performance in a complex water matrix. Compressing the total regeneration window to under 10 minutes offers substantial process-level advantages, including reduced chemical inventory requirements, lower waste brine generation, and enhanced throughput potential in continuous column operations.

### II-4) Optimization of the Regeneration Agent Concentrations in the Two-Step Process

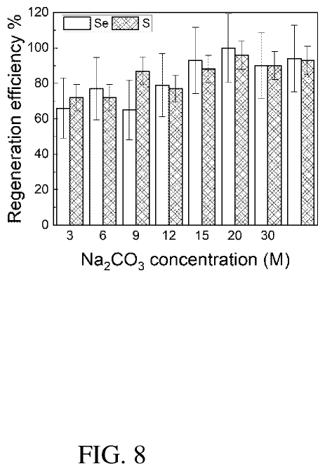

After the kinetics of the two-step protocol was established, optimizing the regeneration agent concentrations was undertaken to achieve a cost-effective performance. To determine the optimal dose of Na₂CO₃ used in the elution step, concentrations ranging from 0.01 M to 2 M were evaluated. The concentration of NaCl used in the regeneration process was kept constant at 1 M. As illustrated in FIG. 8, the regeneration efficiency for both Se and S reached its maximum at a 0.5 M Na₂CO₃ concentration. Further increasing the Na₂CO₃ concentration to 2 M did not improve the regeneration efficiency. Therefore, 0.5 M was selected as the optimal Na₂CO₃ concentration for subsequent experiments. It should also be noted that the experiments in this section used raw real leachate, which provides a harsher matrix than the BBIG-treated leachate for optimizing the concentration effects of the regeneration agent, whereas the low regeneration efficiency was obtained using BBIG-treated leachate. This comparison eliminates BBIG pretreatment as a factor that could account for the improved regeneration performance observed with the two-step protocol.

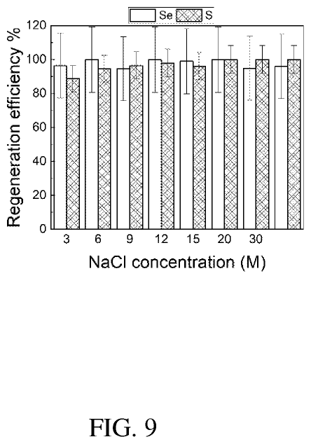

To determine the optimal NaCl concentration for the second step (restoration step) of the process, a similar approach was applied. All tests were started with washing the used resin with a 0.5 M Na₂CO₃ solution, since it exhibited the best balance of efficiency and economy. The NaCl solutions with concentrations ranging from 0.01 M to 2 M were used in the restoration step. Results presented in FIG. 9 show that the optimal NaCl concentration is also 0.5 M. The regeneration efficiency of S increased with increasing NaCl concentration, and achieved complete recovery (100%) at 0.5 M. On the other hand, no clear trend was observed in regeneration efficiency of Se as the NaCl concentration increased. The use of 0.025 M, 0.1 M, and 0.5 M NaCl all resulted in complete recovery, which may be attributed to the low Se concentration (18.5 ppb) in the water that reduced the influence of concentration gradient as the main driving force. Based on these results, it can be concluded that 0.5 M is the optimal concentration for regenerating IRA-900 because it is the only condition under which both S and Se achieved complete recovery.

It is worth emphasizing that, compared to NaCl used in the single-step regeneration, the NaCl restoration step after Na₂CO₃ elution is more effective because the CO₃²⁻ elution changes the resin loading state and enables chloride driven restoration. Although the NaCl concentration effect in FIG. 9 is modest, the minimum concentration that achieved complete recovery is selected as the optimal condition within the scope of this study. This modest concentration dependence may reflect that the concentration range tested was already sufficiently high for the post elution resin restoration, leading to only marginal gains at higher NaCl concentrations. Consequently, an optimized two-step protocol consisting of a 0.5 M Na₂CO₃ wash followed by a 0.5 M NaCl restoration is proposed. This refined protocol provides an optimal, cost-effective regeneration efficiency for IRA-900 resin used in the specific complex industrial wastewater that was treated in this study.

### II-5) Batch and Column Cyclic Studies of the Two-Stage Regeneration Process

To validate the long-term durability and performance of the optimized two-step regeneration protocol in practical scenarios, multi-cycle tests were conducted in both batch and fixed-bed configurations. The protocol was first evaluated in a five-cycle batch study using site-collected industrial wastewater. In each cycle, the resin was loaded with BBIG-treated leachate (containing 17.4 ppb Se and 44.7 ppm S) and subsequently regenerated using the optimized sequence of 0.5 M Na₂CO₃ elution followed by a 0.5 M NaCl restoration. The equilibrium capacity for both Se and S was quantified by Equation 1 after each cycle to assess performance stability.

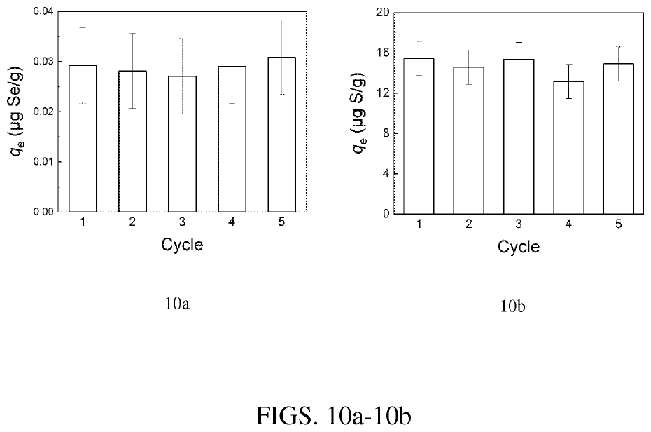

The results, presented in FIGS. 10a and 10b, confirm that the integrated CO₃²⁻-based process effectively preserves the resin's equilibrium capacity across the five consecutive cycles. While minor fluctuations that are common in batch tests with complex real-world matrices were observed, there is no evidence of a consistent fouling.

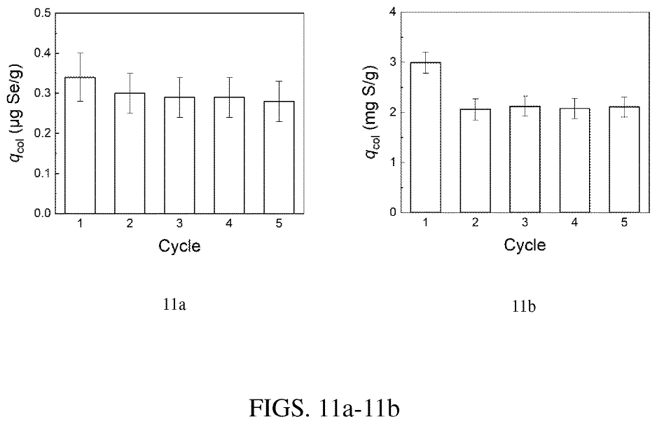

The protocol was further evaluated in a continuous-flow fixed-bed column (2.3 cm in inner diameter and 15 cm in length, packed with 30 g IRA-900), simulating a practical procedure that can be upscaled. The quantitative performance of the column system over five cycles is summarized in FIG. 11. Detailed calculations along with breakthrough profiles for both Se and S over all five consecutive cycles were performed. The results indicate that the sorption capacities achieved in the fixed-bed column (FIG. 11) are significantly higher than those in the batch tests (FIG. 10). This is attributed to the fact that a much larger (~60 times) mass of Se and S passed through the column compared to that used in the batch experiments.

A closer analysis of the column data in FIG. 11 reveals that after five cycles, the resin retained 82% and 70% of its pristine sorption capacities for Se and S, respectively, which demonstrates the durability and reusability of IRA-900 resin under this regeneration protocol. Another notable observation is that the most significant drop in sorption capacity for both Se (~12%) and S (~30%) occurs after the first cycle. In the subsequent cycles (Cycles 2 through 5), the performance stabilizes with only minor fluctuations around a new, lower baseline capacity. Notably, although the regeneration conditions applied here were optimized within this study, complete capacity recovery is not observed for the fixed-bed protocol used to treat real leachate. The largest capacity loss after Cycle 1 suggests that a small fraction of exchange sites becomes unavailable after initial loading, likely due to water matrix effects such as multivalent ions and other constituents that are not fully removed by the carbonate and chloride steps. In addition, elution is governed by ion exchange equilibrium because the elution/regeneration is performed in batch mode to minimize the volume of the elution/regeneration solutions. In the elution step, as Se and S desorb from the resin by CO₃²⁻, the concentration of displaced ions in the elution solution within the bed increases, thus reducing the driving force for further desorption and leaving a small residual fraction on the resin that is in equilibrium with the concentration in the solution. In the restoration step, an analogous ion exchange equilibrium occurs between CO₃²⁻/HCO₃⁻ and Cl⁻, which also limits the extent of Cl⁻ restoration. Both equilibrium limitations contribute to the observed behavior, as supported by the fact that after this initial reduction in the regeneration efficiency, the column approached a stable and reproducible baseline capacity, consistent with the minor changes observed from Cycles 2 to 5. Despite this initial loss, the Na₂CO₃/NaCl regeneration process still maintained a stable and promising sorption capacity during cyclic tests. These results coherently highlight the protocol's potential as a reliable and cost-effective strategy for large-scale application.

The combined results demonstrated that the Na₂CO₃ and NaCl regeneration sequence provides an efficient and reliable approach for restoring resin capacity in treating real industrial wastewater and sustaining high performance over multiple cycles in both batch and column systems. The demonstrated durability highlights its potential as a reliable and cost-effective strategy for large-scale application.

### II-6) Possible Mechanisms of the Two-Step Regeneration Process

The superior performance of the developed two-step protocol, in contrast to the failure of the conventional one-step regeneration in treating real industrial wastewater, can be attributed to distinct chemical driving forces at each stage. To understand how this approach overcomes the strong affinity of the resin for leachate contaminants, the following mechanisms were proposed for the sequential elution and restoration steps.

Since the regeneration steps operate under different solution pH conditions, carbonate speciation which is pH-dependent needs to be considered to determine the

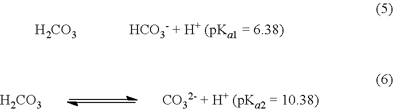

dominant carbonate species present during elution and restoration. The carbonate system can be represented by the following thermodynamic acid-base equilibria at 20° C. (Equations 5 and 6).

Accordingly, CO₃²⁻ is expected to dominate under alkaline Na₂CO₃ elution conditions, whereas a lower pH during restoration shifts carbonate toward HCO₃⁻ and, under acidic conditions, toward carbonic acid (H₂CO₃).

Based on carbonate speciation, the alkaline Na₂CO₃ elution step is expected to provide CO₃²⁻ as the dominant competing anion in solution. This establishes the chemical context for the elution step, in which divalent CO₃²⁻ is available at high concentration. Under these conditions, divalent CO₃²⁻ is expected to be more effective for the elution of sorbed ions than Cl⁻ because SBA resins generally exhibit stronger affinity for higher-valence than for lower-valence anions, a well-known behavior attributed to bi-site pairing at closely spaced quaternary ammonium groups. As also well known, the significant concentration gradient provides an additional driving force for the displacement of oxyanions bounded in the resin. Therefore, the combined effects of valence and concentration gradient enable effective desorption of oxyanions from the resin in the elution step. The reaction of this displacement (desorption) process is proposed in Equation 7 below:

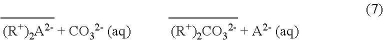

where R̅⁺̅ denotes the resin's functional group and A²⁻ denotes the sorbed oxyanions, such as SeO₄²⁻ and SO₄²⁻. It should also be noted that, under the alkaline Na₂CO₃ elution conditions, OH⁻ may also participate in anion exchange, whereas CO₃²⁻ is still considered to be the dominant competing anion for displacement of sorbed oxyanions because of the higher valence and much higher concentration than OH⁻.

In the second step, the resin is restored to its chloride form with either NaCl or HCl. For the restoration step using HCl, the acidic pH shifts carbonate speciation toward H₂CO₃, and the resin-phase CO₃²⁻ can be protonated accordingly. The resulting H₂CO₃ then decomposes to CO₂ and water, freeing the exchange sites previously occupied by CO₃²⁻. The Cl⁻ ions in solution re-occupy these sites afterwards, restoring the resin to its chloride form. The overall process is shown by Equations 8 and 9.

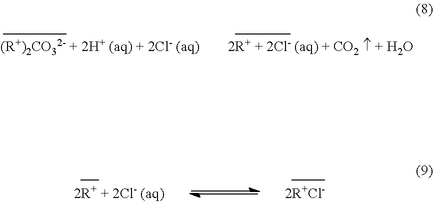

During NaCl addition, on the other hand, restoration is known to be primarily driven by mass action from excess external chloride concentration, which displaces resin-phase CO₃²⁻. Although SBA resins are known to prefer divalent anions over monovalent ones, under a relatively high concentration of a regeneration agent, the concentration gradient outweighs the valence effect, which permits efficient replacement of carbonate by Cl⁻. The reaction of this displacement (restoration) process is shown in Equation 10.

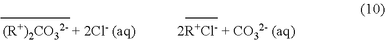

The thermodynamic evaluation for the CO₃²⁻ elution (Equation 7) and Cl⁻ restoration with NaCl (Equation 10) steps were undertaken, and these demonstrate that both reactions are spontaneous and thermodynamically favorable. In parallel, considering carbonate speciation, the restoration step can occur at a lower pH than the Na₂CO₃ elution step, which shifts a portion of CO₃²⁻ toward HCO₃⁻ and provides a pH-based basis for the equilibrium shown in Equation 11.

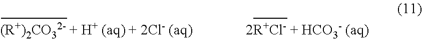

The monovalent HCO₃⁻ is expected to be more readily displaced by Cl⁻ than CO₃²⁻ due to the valence preference of SBA resins, thereby promoting Cl⁻ restoration from a valence perspective, while the concentration gradient remains the primary driving force for both exchanges. Furthermore, removal of resin-phase HCO₃⁻ by Cl exchange could also pull Equation 11 to the right, enabling continued conversion of CO₃²⁻ to HCO₃⁻ and further facilitating overall restoration.

From the perspective of the improved performance of the two-step regeneration in real leachate compared to the one-step NaCl regeneration, a reasonable hypothesis is that coexisting multivalent metal ions in the real leachate hinder ion exchange and reduce the effectiveness of Cl regeneration. Addition of divalent CO₃²⁻ facilitates displacement of these multivalent ions from the resin, thereby maintaining a high availability of sorption sites. Powder X-ray diffraction (PXRD) of the BBIG-SO₄ and BBIG-SeO₄ solids showed no evidence of additional crystalline phases attributable to bulk metal SO₄²⁻ or metal SeO₄²⁻ precipitation. Accordingly, the improved regeneration observed with CO₃²⁻ treatment is most consistently attributed to more effective displacement of SO₄²⁻ and SeO₄²⁻ from the resin compared to the displacement achieved with chloride alone, rather than other mechanisms such as complexation or precipitation. CO₃²⁻ complexation or precipitation may occur, but this is a secondary effect that does not alter the primary interpretation.

### CONCLUSIONS

The focus of this work is the regeneration performance and mechanistic interpretation of regeneration behavior, providing fundamental insights into ion-exchange regeneration across different water matrices. During the removal of Se in real industrial wastewaters, IRA-900 ion-exchange resin displayed promising capability. Conventional one-step regeneration approach (e.g., with NaCl), although working effectively for wastewater simulants or simple aqueous solutions, failed in real-world applications where competitive ions are present and reduced the regeneration efficiency. To overcome this limitation, a two-step regeneration protocol was herein developed and optimized consisting of a Na₂CO₃ elution step followed by a NaCl restoration step. This integrated approach consistently restored more than 80% of the resin's capacity, compared to less than 20% recovery using a single-step NaCl regeneration. The two-step protocol performance was interpreted mechanistically by incorporating pH-dependent carbonate speciation across both steps, with CO₃²⁻ driven elution explained by preferential displacement of sorbed oxyanions by higher-valence and mass action at high concentration, followed by NaCl restoration that returns the resin toward its original form through Cl⁻ replacement driven mainly by Cl⁻ mass action at high concentration. The protocol was then optimized to achieve short contact times (<10 minutes in total) and moderate dosages of chemicals (0.5 M for both Na₂CO₃ and NaCl) in treating real leachate. Multi-cycle tests in both batch and continuous-flow fixed-bed systems coherently demonstrated potential to maintain resin's efficiency and stability in a long term with this protocol.

In separate experiments, the economic viability of the protocol in large scale applications was also evaluated, with techno-economic analysis based on process modeling and field data. Overall, the development and interpretation of this two-step strategy provides a practical and sustainable solution to a key limitation in ion-exchange technology and greatly enhances its applicability for treating complex industrial wastewaters. Even though this study is focused on removing Se in a S-rich leachate using IRA-900, the described approach can be broadly extended to other SBA resins, particularly those in chloride form. For a broader application of this regeneration approach, future studies may also extend the underlying principles of this carbonate/chloride two-step regeneration to other strong-base anion resins and to wastewaters containing a broader range of oxyanion contaminants.

Extended cycling studies beyond five regenerations are commonly considered to establish ultimate resin lifetime and confirm long term operability for specific process streams, with precipitation formation as one primary concern. In many practical applications, however, precipitation is not a problem because ion exchange is implemented following pretreatment where precipitating species are removed prior to the ion exchange process. One example is the DeSelenator process, where precipitation is used to remove a variety of ions and ion exchange is used as a polishing step to remove the remaining SeO₄²⁻, SeO₃²⁻, and SO₄²⁻ species. Other examples can be found in the mining industry, where ion exchange is used to recover the product, including in situ uranium mining where the concentration of precipitating ions is low. Even in cases where some precipitation may occur during long term operation, ion exchange with CO₃²⁻ elution can still be used, with the resin periodically washed using a low concentration acidic solution, for example 0.05 M HCl.

While there have been shown and described what are at present considered the preferred embodiments of the invention, those skilled in the art may make various changes and modifications which remain within the scope of the invention defined by the appended claims.

What is claimed is:

1. A method for regenerating a strong-base anion (SBA) exchange resin containing quaternary ammonium groups, the method comprising:
(i) a first washing step in which the SBA exchange resin is washed with a first aqueous solution of a salt containing a divalent or trivalent anion, wherein the salt is present in the first aqueous solution in a concentration of at least 0.001 M and up to the solubility limit of the salt; and
(ii) a second washing step in which the SBA exchange resin is washed with a second aqueous solution of XY, wherein X is H or an alkali element and Y is Cl⁻ or NO₃⁻, wherein XY is present in the second aqueous solution in a concentration of 0.01 M to 2 M.

2. The method of claim 1, wherein the quaternary ammonium groups in the SBA exchange resin comprise trimethyl ammonium groups.

3. The method of claim 1, wherein the quaternary ammonium groups in the SBA exchange resin comprise dimethyl ethanolammonium groups.

4. The method of claim 1, wherein the SBA exchange resin is crosslinked with divinylbenzene (DVB).

5. The method of claim 1, wherein the SBA exchange resin contains a copolymeric styrene-divinylbenzene crosslinked scaffold in which the quaternary ammonium groups are embedded.

6. The method of claim 1, wherein the salt contains a divalent anion.

7. The method of claim 6, wherein the divalent anion is selected from the group consisting of carbonate (CO₃²⁻), hydrogen phosphate (HPO₄²⁻), and oxalate.

8. The method of claim 1, wherein the salt contains a trivalent anion.

9. The method of claim 8, wherein the trivalent anion is phosphate (PO₄³⁻) or borate (BO₃³⁻).

10. The method of claim 1, wherein, after the second washing step, the SBA exchange resin is rinsed with DI water.

11. The method of claim 1, wherein the second aqueous solution contains XCl wherein X is an alkali element.

12. The method of claim 11, wherein XCl is NaCl.

13. The method of claim 1, wherein the second aqueous solution contains HCl.

14. The method of claim 1, wherein the resin, before regeneration, contains one or more residual anions selected from the group consisting of sulfate (SO₄²⁻), sulfite (SO₃²⁻), selenate (SeO₄²⁻), selenite (SeO₃²⁻), tellurate (TeO₄²⁻), chromate (CrO₄²⁻), molybdate (MoO₄²⁻), and tungstate (WO₄²⁻), and said residual anions are replaced by chloride anion after the second washing step.

15. The method of claim 1, wherein the resin, before regeneration, contains one or more residual anions that contain at least one element having an atomic number greater than 20, and said residual anions are replaced by chloride anion after the second washing step.

16. The method of claim 15, wherein the resin, before regeneration, contains one or more anions that contain at least one transition, lanthanide, or actinide metal.

17. The method of claim 1, wherein the first washing step and/or second washing step is conducted at a temperature of 20-30° C.

18. The method of claim 1, wherein the first washing step and/or second washing step is conducted at a temperature of 30-60° C.

19. The method of claim 1, wherein the salt is present in the first aqueous solution in a concentration of 0.001 M to 2.5 M.

20. The method of claim 1, wherein the salt is present in the first aqueous solution in a concentration of 0.001 M to 2 M.

21. The method of claim 1, wherein the salt is present in the first aqueous solution in a concentration of 0.25 M to 2.5 M.

22. The method of claim 1, wherein the salt is present in the first aqueous solution in a concentration of 0.25 M to 2 M.

23. The method of claim 1, wherein the XCl is present in the second aqueous solution in a concentration of 0.25 M to 2 M.

24. The method of claim 1, wherein the XCl is present in the second aqueous solution in a concentration of 0.5 M to 2 M.

25. The method of claim 1, wherein the SBA exchange resin is held within a column, and the first and second washing steps are conducted by eluting first and second aqueous solutions, respectively, through the column.
